(19) United States
(12) Patent Application Publication
(10) Pub. No.: US 2017/0326696 A1
(43) Pub. Date: Nov. 16, 2017

(54) REMOTE CONTROL POWER TOOL AND METHOD

(71) Applicant: DARYLL HALVERSON, ELOY, AZ (US)

(72) Inventor: DARYLL HALVERSON, ELOY, AZ (US)

(21) Appl. No.: 15/593,270

(22) Filed: May 11, 2017

Related U.S. Application Data
(60) Provisional application No. 62/335,038, filed on May 11, 2016.

(51) Int. Cl. B23Q 1/00; B23D 59/00; B23K 9/10; B23Q 17/24

(52) U.S. Cl. CPC B23Q 1/0045; B23Q 17/2409; B23D 59/001; B23K 9/1087

(57) ABSTRACT

A remote control power tool for a working material including a support configured to support the working material, a power tool fixed to the support, at least one actuator configured to move the working material, a user interface remote from the power tool, a controller communicably coupled to the user interface, video camera proximate the power tool, and a visual display proximate the user interface.

### CROSS-REFERENCE TO RELATED APPLICATION

The present application is related to and claims priority to U.S. Provisional Patent Application No. 62/335,038 filed May 11, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of power tools and more specifically relates to power tool accessories.

### 2. Description of Related Art

Working with machines such as, saws, routers, and/or welders and other devices can be a dangerous situation. People can be injured by flying objects from such machines. A person may slowly lose their hearing from the loud noise emitted from being in close proximity to a machine. Also, an individual using an electric welder can be exposed to very strong light. People in close proximity to running machines and equipment can be exceptionally risky and dangerous. Safety devices such as ear plugs, goggles, and the like, may not be sufficient for adequate and prolonged protection. A suitable solution is desired.

U.S. Pat. No. 5,123,464 to Harry Van Gelder relates to a table saw power feed. The described table saw power feed includes board pulling device for use with a powered table saw or similar woodworking tool. The puller is readily removable and attachable to most similar tools and uses a novel springing roller to hold the work piece against the pulling roller. The puller is mounted so that it can be moved out of the path of the piece being sawed, or back into place to pull the work piece through the tool. Further, if desired, the entire device is readily removable from the tool.

### BRIEF SUMMARY OF THE INVENTION

In view of the foregoing disadvantages inherent in the known motor driven devices art, the present disclosure provides a novel remote control power tool for a working material and method. The general purpose of the present disclosure, which will be described subsequently in greater detail, is to provide a remote control power tool for a working material and method.

A remote control power tool for a working material is disclosed herein. The remote control power tool includes a support configured to support the working material, a power tool fixed to the support, at least one actuator configured to move the working material, a user interface remote from the power tool, a controller communicably coupled to the user interface, video camera proximate the power tool, and a visual display proximate the user interface.

According to another embodiment, a method of using a remote control power tool is also disclosed herein. method of using a remote control power tool includes a first step, providing a remote control power tool, the remote power tool including a support, a powered tool, an actuator configured to feed a working material to the powered tool, a user interface operable remotely from the powered tool, and a controller configured to operate the powered tool and the actuator from a remote location in real-time response to the user interface; a second step, placing the working material upon the support in a first orientation; a third step, engaging the working material with the actuator; a fourth step, performing a first operation on the working material via the actuator feeding the working material in the first orientation to powered tool in real-time response to the user interface, and the powered tool modifying the working material remotely from the user interface; a fifth step, removing the working material from the support; a sixth step, placing the working material upon the support in a second orientation different from the first orientation; a seventh step, engaging the working material with the actuator; an eighth step, performing a second operation on the working material via the actuator feeding the working material in the second orientation to powered tool in real-time response to the user interface, and the powered tool further modifying the working material remotely from the user interface; and a ninth step, removing the working material from the support.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a remote control power tool for a working material and method, constructed and operative according to the teachings of the present disclosure.

FIG. 1 is a perspective view of the remote control power tool during an ‘in-use’ condition, according to an embodiment of the disclosure.

FIG. 2 is a front view of the remote control power tool of FIG. 1, according to an embodiment of the present disclosure.

FIG. 3 is a top view of the remote control power tool of FIG. 1, according to an embodiment of the present disclosure.

FIG. 4 is a perspective view of the user interface of the remote control power tool of FIG. 1, according to an embodiment of the present disclosure.

FIG. 5 is a flow diagram illustrating a method of using a remote control power tool, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a motor driven device and more particularly to a remote control power tool for a working material as used to improve the safety of using a power tool by a user by increasing the distance of which the user can be located to operate the power tool.

Generally, a remote control power tool for a working material provides for precise control over an actuator to move the working material. The device may feature a visual display, integrated circuits, one or more control knobs, light emitting diode (“LED”) lights, wires, a printed circuit board, and connectors. The device may allow users to control a device or machine from distance, improving safety on a worksite or in a workshop. As designed, the device may include a small video camera designed to offer views to the user when a machine is in use. The present invention offers a way to protect the user from physical danger (e.g., debris, sound, light, etc.) while on a construction site, performing roadwork, in a workshop, or performing other similar tasks. The actuator may include a stepper motor and the at least one actuator may be removably coupleable to the support. Also the at least one actuator may include a plurality of actuators where the plurality of actuators are configured to operate in unison or independently from each other.

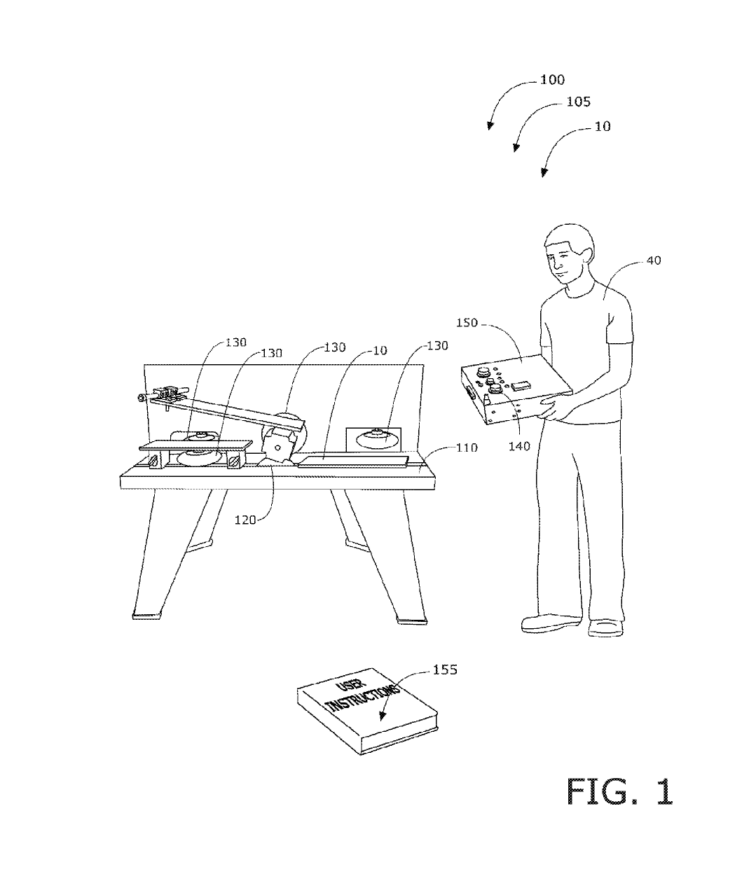

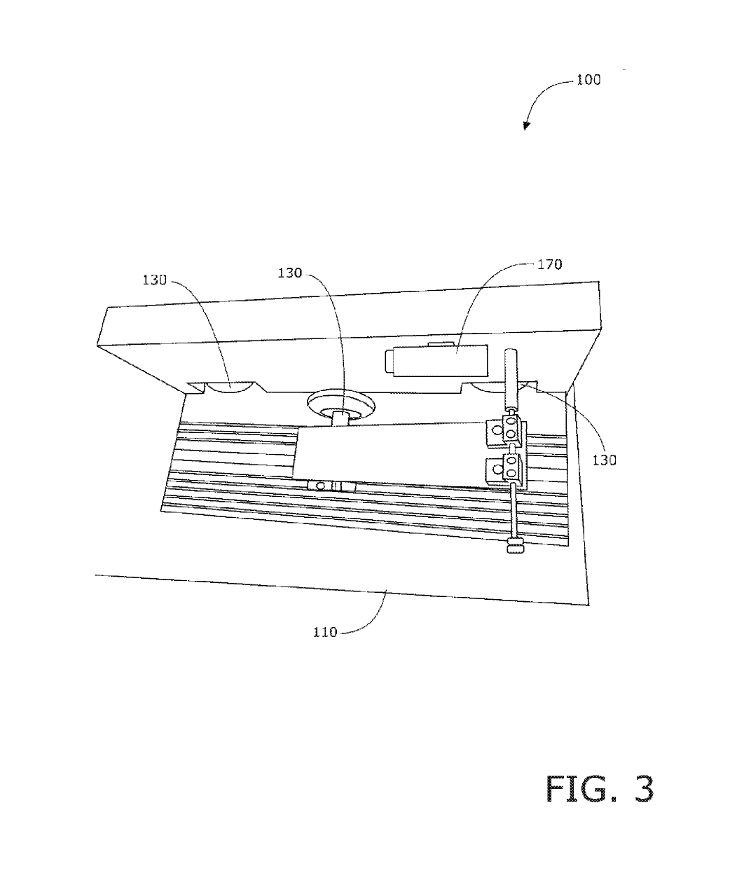

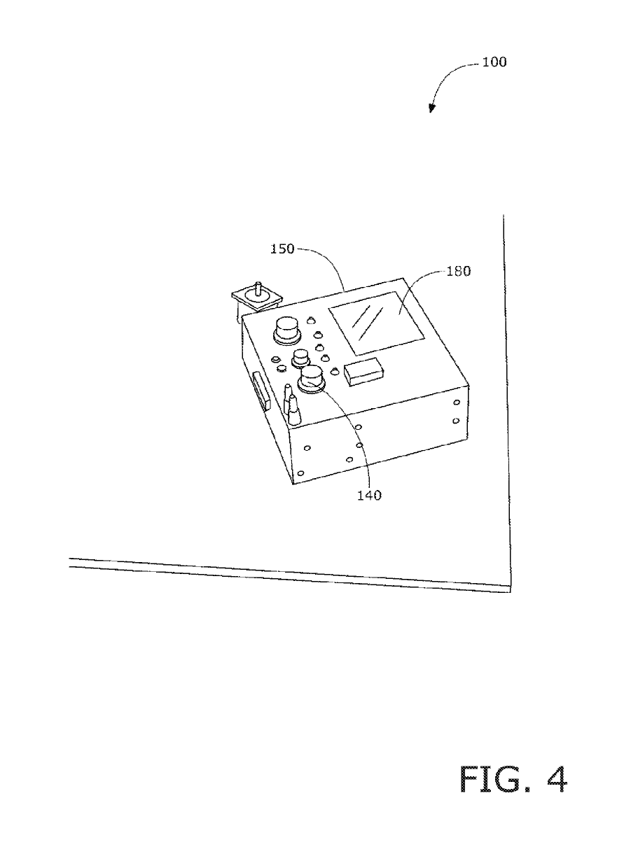

Referring now more specifically to the drawings by numerals of reference, there is shown in FIGS. 1-4, various views of a remote control power tool for a working material 100. FIG. 1 shows a remote control power tool for a working material during an ‘in-use’ condition 50, according to an embodiment of the present disclosure. Here, remote control power tool for a working material 100 may be beneficial for use by a user 40 to provide control of a powered machine to modify working material 10, with the user 40 located at a safe distance from the working material 10 and machine (power tool 120) to improve safety.

As illustrated, the remote control power tool for a working material 100 may include support 110 configured to support working material 10, power tool 120 fixed to support 110, and configured to perform work on working material 10, at least one actuator 130 configured to move working material 10, user interface 140 remote from power tool 120 (user interface 140 configured to receive and communicate an operational input from user 40 in real-time), and controller 150 communicably coupled to user interface 140 (controller 150 configured receive the operational input communicated from user interface 140 and to operate actuator 130 in real-time and responsive to the operational input received from user interface 140).

Embodiments of remote control power tool 100 may further include controller 150 further configured to operate power tool 120. User interface may be further configured to receive and communicate the operational input from the user in real-time while at a distance of at least 10 feet from said power tool. As shown, the remote control power tool 100 may include a plurality of actuators 130. For example, plurality of actuators 130 are embodied here as four motor-driven wheels configured to linearly propel the working material 10 while the working material 10 is in a horizontal orientation and again in a vertical orientation.

According to one embodiment, the remote control power tool 100 may be arranged as a kit 105. In particular, the remote control power tool 100 may further include a set of instructions 155. Instructions 155 may detail functional relationships in relation to the structure of the remote control power tool 100 (such that remote control power tool 100 can be used, maintained, or the like, in a preferred manner).

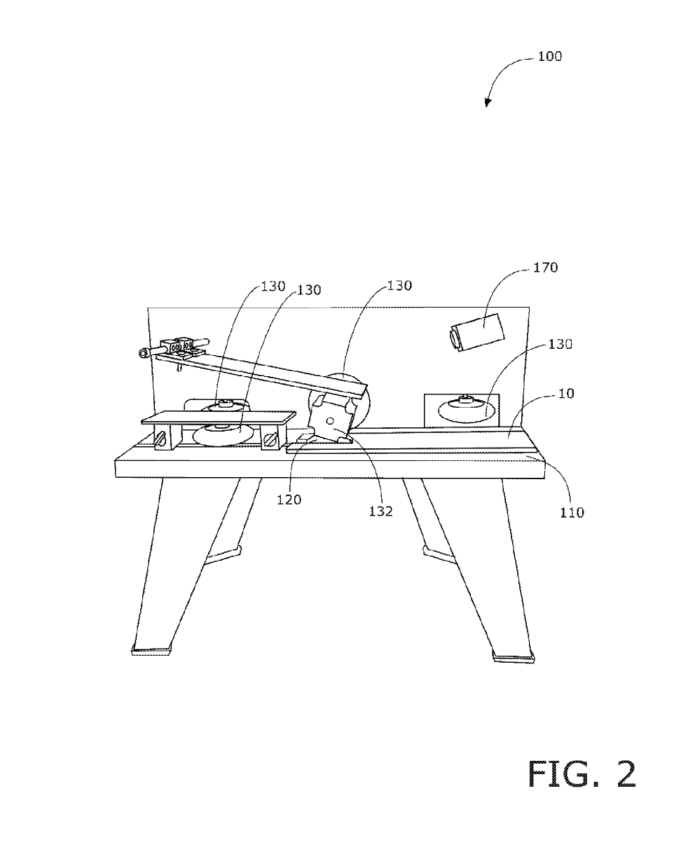

FIGS. 2, 3 and 4 show the remote control power tool 100 of FIG. 1, according to an embodiment of the present disclosure. As shown, the remote control power tool 100 may also include video camera 170 proximate the power tool 120 and arranged to stream real-time video and may also include visual display 180 proximate to user interface and configured to display the real-time video of video camera 170 to the user in real-time such that user 40 (FIG. 1) may view working material 10, support 110, and actuator 130. In some embodiments actuator 130 may include stepper motor 132. Additional embodiments may also include actuator 130 which may include a linear actuator. Other embodiments may include other types of actuator(s) 130 depending upon specific uses and user 40 preferences. Preferably, the actuator includes a stepper motor and the at least one actuator is removably coupleable to the support. Also the at least one actuator includes a plurality of actuators where the plurality of actuators are configured to operate in unison with each other.

At least one actuator 130 may removably coupleable to support 110 in some embodiments. Some embodiments may include at least one actuator 130 which may include a plurality of actuators 130. In embodiments including a plurality of actuators 130, plurality of actuators 130 may be operable independently of each other via controller 150. Embodiments may also include plurality of actuators 130 configured to operate in unison with each other.

Power tool 120 may include a router, a table saw, a circular saw, a welder, a drill, and/or a band saw in embodiments. Other embodiments may include other types of tools.

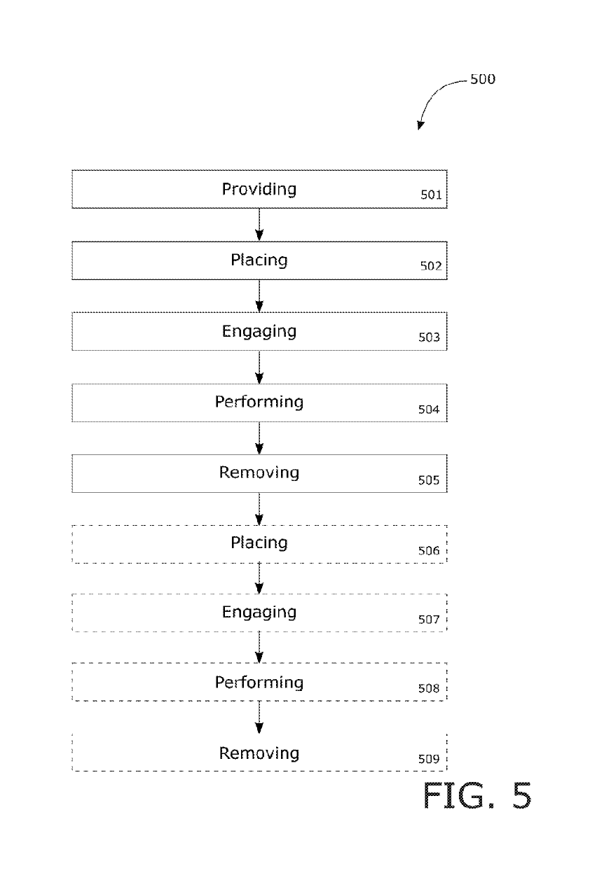

FIG. 5 is a flow diagram illustrating a method of using a remote control power tool 500, according to an embodiment of the present disclosure. In particular, the method of using a remote control power tool 500 may include one or more components or features of the remote control power tool 100 for a working material 10 as described above. As illustrated, the method of using a remote control power tool 500 may include the steps of: step one 501, providing a remote control power tool 100, with remote power tool 100 including support 110, a powered tool, actuator 130 configured to feed working material 10 to the powered tool, user 140 interface operable remotely from the powered tool, and controller 150 configured to operate the powered tool and actuator 130 from a remote location in real-time response to user interface 140; step two 502, placing working material 10 upon support 110 in a first orientation; step three 503, engaging working material 10 with actuator(s) 130; step four 504, performing a first operation on working material 10 via actuator 130 feeding working material 10 in the first orientation to the powered tool in real-time response to user interface 140, and the powered tool modifying working material 10 remotely from user interface 140; step five 505, removing working material 10 from support 110. In addition, the method of using a remote control power tool 500 may further include the steps of: step six 506, placing working material 10 upon support 110 in a second orientation different from the first orientation; step seven 507, engaging working material 10 with the actuator 130; step eight 508, performing a second operation on working material 10 via actuator 130 feeding working material 10 in the second orientation to powered tool in real-time response to user interface 140, and the powered tool further modifying working material 10 remotely from user interface 140; and step nine 509, removing working material 10 from support.

It should be noted that step six 506, step seven 507, step eight 508, and step nine 509 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods of using a remote control power tool (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A remote control power tool for a working material, the remote control power tool comprising:
a support configured to support the working material;
a power tool fixed to the support, and configured to perform work on the working material;
at least one actuator configured to move the working material;
a user interface remote from the power tool, said user interface configured to receive and communicate an operational input from a user in real-time; and
a controller communicably coupled to the user interface, said controller configured receive the operational input communicated from said user interface and to operate the actuator in real-time and responsive to the operational input received from said user interface.

2. The remote control power tool of claim 1, wherein the controller is further configured to operate the power tool.

3. The remote control power tool of claim 1, wherein the user interface is further configured to receive and communicate the operational input from the user in real-time while at a distance of at least 10 feet from said power tool.

4. The remote control power tool of claim 1, further comprising:
a video camera proximate the power tool and arranged to stream real-time video; and
a visual display proximate the user interface and configured to display the real-time video of the video camera to the user in real-time.

5. The remote control power tool of claim 1, wherein the actuator includes a stepper motor.

6. The remote control power tool of claim 1, wherein the actuator includes a linear actuator.

7. The remote control power tool of claim 1, wherein the power tool includes a router.

8. The remote control power tool of claim 1, wherein the power tool includes a table saw.

9. The remote control power tool of claim 1, wherein the power tool includes a circular saw.

10. The remote control power tool of claim 1, wherein the power tool includes a welder.

11. The remote control power tool of claim 1, wherein the power tool includes a drill.

12. The remote control power tool of claim 1, wherein the power tool includes a band saw.

13. The remote control power tool of claim 1, wherein the at least one actuator is removably coupleable to the support.

14. The remote control power tool of claim 1, wherein the at least one actuator includes a plurality of actuators.

15. The remote control power tool of claim 14, wherein the plurality of actuators are operable independently of each other via the controller.

16. The remote control power tool of claim 14, wherein the plurality of actuators are configured to operate in unison with each other.

17. A remote control power tool for a working material, the remote control power tool comprising:
a support configured to support the working material;
a power tool fixed to the support, and configured to perform work on the working material;
at least one actuator configured to move the working material;
a user interface remote from the power tool, said user interface configured to receive and communicate an operational input from a user in real-time;
a controller communicably coupled to the user interface, said controller configured receive the operational input communicated from said user interface and to operate the actuator in real-time and responsive to the operational input received from said user interface;
a video camera proximate the power tool and arranged to stream real-time video; and
a visual display proximate the user interface and configured to display the real-time video of the video camera to the user in real-time; and and
wherein the controller is further configured to operate the power tool;
wherein the user interface is further configured to receive and communicate the operational input from the user in real-time while at a distance of at least 10 feet from said power tool;
wherein the at least one actuator includes a stepper motor;
wherein the at least one actuator is removably coupleable to the support;
wherein the at least one actuator includes a plurality of actuators; and
wherein the plurality of actuators are configured to operate in unison with each other.

18. The remote control power tool of claim 17, further comprising set of instructions; and
wherein the remote control power tool is arranged as a kit.

19. A method of using a remote control power tool, the method comprising the steps of:
providing a remote control power tool, said remote power tool including a support, a powered tool, an actuator configured to feed a working material to the powered tool, a user interface operable remotely from the powered tool, and a controller configured to operate the powered tool and the actuator from a remote location in real-time response to the user interface;
placing the working material upon the support in a first orientation;
engaging the working material with the actuator;
performing a first operation on the working material via the actuator feeding the working material in the first orientation to powered tool in real-time response to the user interface, and the powered tool modifying the working material remotely from said user interface; and
removing the working material from said support.

20. The method of claim 19, further comprising the steps of:
placing the working material upon the support in a second orientation different from the first orientation;
engaging the working material with the actuator;
performing a second operation on the working material via the actuator feeding the working material in the second orientation to powered tool in real-time response to the user interface, and the powered tool further modifying the working material remotely from said user interface; and
removing the working material from said support.
